(19) United States
(12) Patent Application Publication
(10) Pub. No.: US 2012/0205322 A1
(43) Pub. Date: Aug. 16, 2012

(54) METHOD FOR OXIDATION TREATMENT OF A SUBSTRATE FOR THE ADSORPTION OF RADIONUCLIDES

(75) Inventors: Jean-Louis Decossas, Cieux (FR); Pierre Krausz, Isle (FR); Vincent Gloaguen, Limoges (FR); Loic Jauberty, Limoges (FR); Cedric Astier, Vicq Sur Breuilh (FR); Alexandre Berland, Bessines Sur Gartempe (FR); Anne Royer, Limoges (FR); Isabelle Niort, Nieul (FR); Valerie Granger, Limoges (FR)

(73) Assignee: PE@RL, LIMOGES (FR)

(21) Appl. No.: 13/500,795

(22) PCT Filed: Oct. 8, 2010
(86) PCT No.: PCT/FR10/52122

§ 371 Date: Apr. 6, 2012

(30) Foreign Application Priority Data
Oct. 8, 2009 (FR) 0957024

(51) Int. Cl. B01D 37/00; B01J 20/24

(52) U.S. Cl. 210/749; 502/404

(57) ABSTRACT

A process for the treatment of a substrate made of lignocellulosic material for the adsorption of radionuclides in fluids that are loaded with radionuclides, includes carrying out the following stages: preparation of lignocellulosic material that is divided by rinsing and subjected to granulometric sorting; submission of the lignocellulosic material to an oxidation; activation of the material by an acid treatment; and rinsing. The oxidation is more particularly a Fenton reaction. A method of using the lignocellulosic material treated by the process is also described.

This invention relates to a process for oxidation treatment of a substrate that is made of lignocellulosic material for the adsorption of radionuclides in fluids that are loaded with radionuclides. This invention also covers the substrate that is obtained by the process.

By way of example, in the field of industry, there are sites for mining natural materials such as uranium or certain other more common metals such as lead, nickel, chromium, zinc, and copper. In the case of uranium, it is found in the mineral materials (granite, gneiss, . . . ). Its extraction is done in particular by the static lixiviation method (in situ (ISL) or pile method (ETL [Extract, Transform, Load])) or the dynamic lixiviation method using an acid or alkaline solution depending on the nature of the source rock or by the in-situ recovery method (ISR) thanks to the injection of oxygen and carbon dioxide in the rock. These methods make it possible to dissolve the uranium. Numerous quantities of fluids are used. Certain fluids are recycled, and others require treatment often for the purpose of their disposal in the environment.

It would be all the more attractive to be able to treat this fluid waste in the same way as the possible atmospheric waste generated using processes that make use of natural renewable and recyclable materials.

In addition, when certain sites are abandoned, natural flowing and/or streaming waters are loaded with radionuclides. Also, for the purpose of their use (garden spraying, swimming, supply, . . . ), it proves necessary to treat these waters so as to remove these radionuclides.

The same holds true for heavy metals in certain extraction mines, or in certain metal transformation industries.

These treatments can be extended, without being exhaustive, to drinking water as well as to water that comes from oceans, seas, rivers, lakes, ponds, reservoirs, rivers and streams in which radionuclides are naturally present or are obtained from industrial pollution.

It seems that the current industrial treatments for recovery of radionuclides have the drawback of resorting to processes that ultimately generate wastes that it is then necessary to dispose of so that the problem is shifted but not resolved.

Thus, to ensure a treatment that goes in the direction of the recyclable, the accessible renewable resource is a substrate that is made of lignocellulosic material and in particular bark. This invention proposes the use of this substrate for ensuring the treatment of the water that is loaded with heavy metals and in particular for removing the radionuclides that are present.

The Japanese Patent Application JP 60172348 that is known and that describes a process for manufacturing a bark-based substrate, able to adsorb heavy metals directly from the sea water and spent waters, is known.

In this prior art, the bark is dried, ground and treated with acid to activate the chemical ion-exchange functions of the bark, in this case nitric acid, and then the soluble products of the bark are stabilized with formaldehyde. Washing and drying phases complete the process between these two active stages.

The thus-mentioned prior art has a major drawback that consists in using formaldehyde of which it is known that it is toxic and carcinogenic.

The problem posed is not only to avoid the sanitary risks linked to the formaldehyde but it also poses other problems, such as the one for the release of water-soluble products.

When a substrate for treatment of fluids that are loaded with heavy metals is prepared, it is necessary to prevent any release of water-soluble products such as tannins or other phenolic compounds in particular, which would generate pollution of the liquids exiting during the treatment of heavy metals, without high additional toxicity but nevertheless it is advisable to avoid it.

That is, these water-soluble compounds are allowed, but their release is prevented by stabilizing them in the bark. Thus, the water-soluble compounds are still present in the bark without disrupting the heavy-metal capture function and without release into the fluid solutions that are disposed of after adsorption of said heavy metals; this is not the method adopted in this invention.

In this process, another solution consists in removing these water-soluble compounds. This method no longer seems desirable a priori because it generates costs that are incompatible with proper industrial profitability, although it is currently little used.

The invention proposes to remedy these problems by providing a satisfactory industrial solution.

Taking into account the evolution of the treatments and the normal and rational tendency to resort to treatments that are the most “green” possible, i.e., limiting the impacts on the environment, it is advisable to seek a suitable compound that allows the solubilization and the preliminary removal of the water-soluble compounds of the substrate before it is used for adsorbing the radionuclides.

Other means are known for recovering the radionuclides that consist in making use of humic compounds such as peat or compost because these humic compounds capture the cations of heavy metals. It is possible to refer to the references of the following patent applications: WO-2006/096472, DE-19,925601 or also U.S. Pat. No. 5,602,071. The problem with these humic compounds is their low permeation capacity, which restricts them to trials or to tests in small quantities but makes them difficult to use with satisfactory results in the industrial environment for large treatment volumes within short time limits.

This invention proposes solubilizing these water-soluble compounds by a chemical treatment by relying on a so-called Fenton oxidation stage.

To illustrate this description, drawings are attached in which the different figures show:
FIG. 1: Curve q based on Cᵣₑₛ for the bark that is treated with acid and used as a control, in the case of an application to the adsorption of lead,

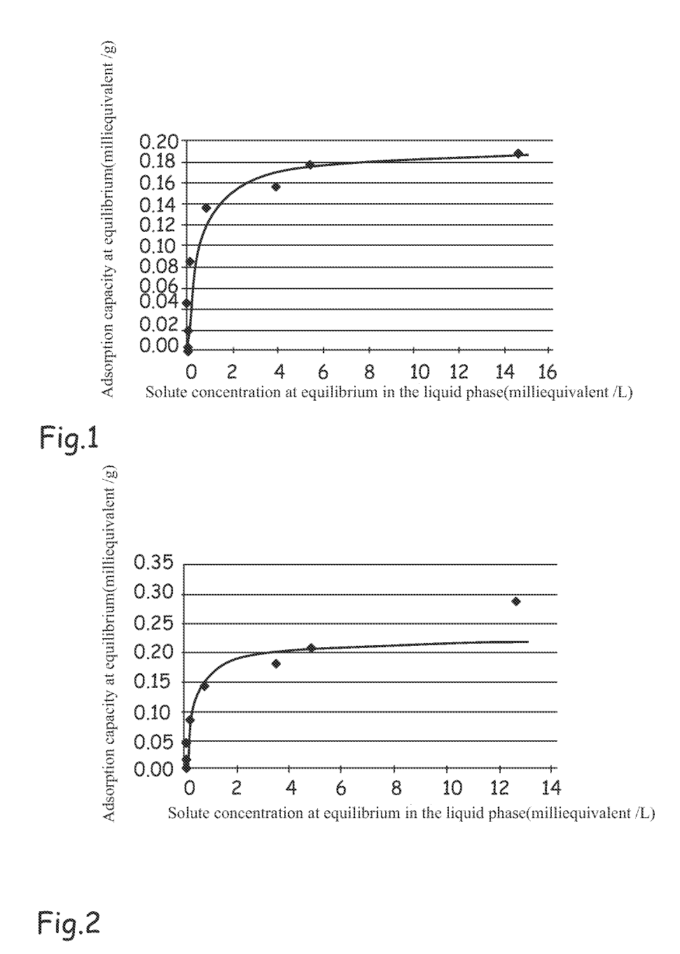

FIG. 2: Curve q based on Cᵣₑₛ for the bark that is treated with acid and that has undergone the Fenton oxidation reaction according to this invention, in the case of an application to the adsorption of lead,

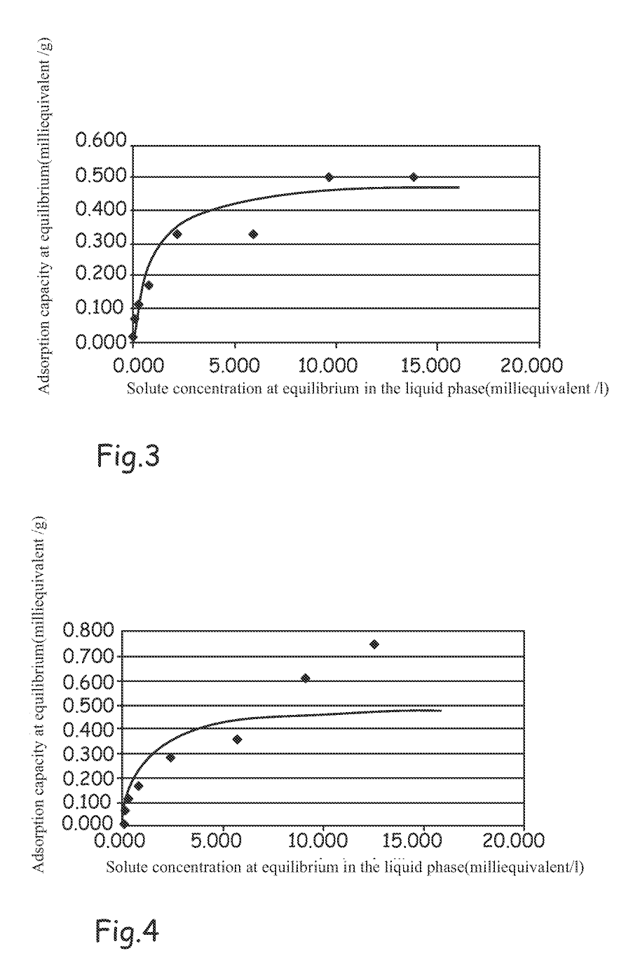

FIG. 3: Curve q based on Cᵣₑₛ for the bark that is treated with acid and used as a control, in the case of an application to the adsorption of uranium,

FIG. 4: Curve q based on Cᵣₑₛ for the bark that is treated with acid and that has undergone the Fenton oxidation reaction according to this invention, in the case of an application to the adsorption of uranium,

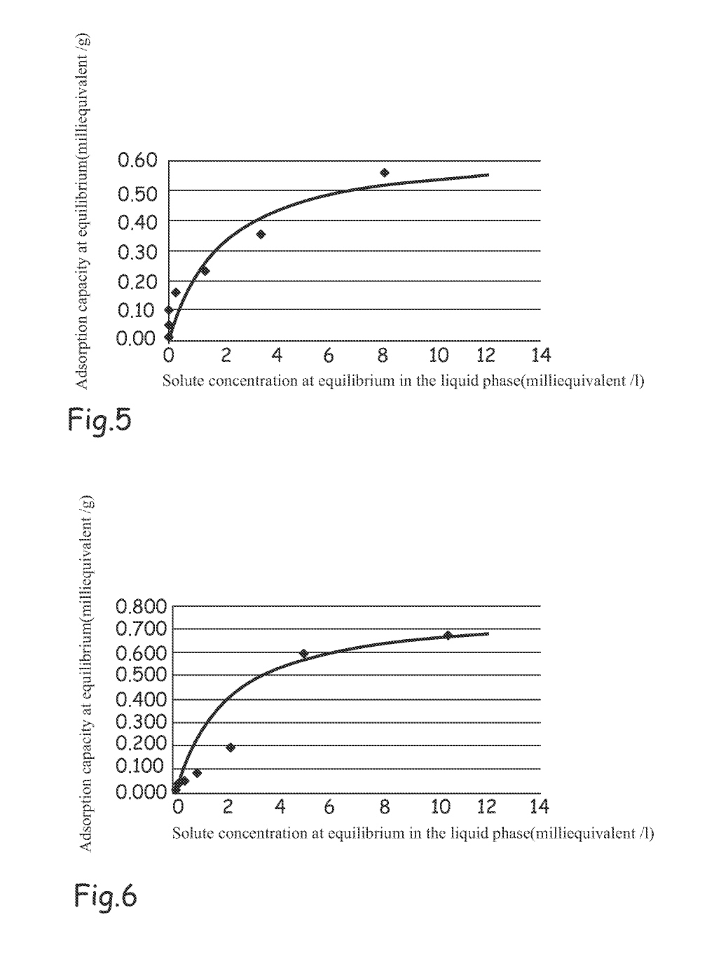

FIG. 5: Curve q based on Cᵣₑₛ for the bark that is treated with acid and used as a control, in the case of an application to the adsorption of barium,

FIG. 6: Curve q based on Cᵣₑₛ for the bark that is treated with acid and that has undergone the Fenton oxidation reaction according to this invention, in the case of an application to the adsorption of barium.

The process for oxidation treatment of a substrate that is made of lignocellulosic material for the adsorption of radionuclides in fluids that are loaded with radionuclides according to this invention consists in subjecting said substrate that is made of lignocellulosic material to a treatment that is designed to improve its attachment capability of said radionuclides as well as to solubilize the water-soluble products.

In the non-limiting embodiment that is now described by way of example, bark in particular of wood origin, in particular Douglas fir, ground into granules, with dimensions of several millimeters, 1 to 4 mm, to provide an estimate, is used as a substrate that is made of lignocellulosic material.

In a first step, this bark is ground and calibrated in order to retain only the desired granulometric range. It is noted that this granulometric range depends on the nature of the bark.

The selection of this range has a double objective.

The minimum grain size should prevent the clogging during the use of the material in various packaging systems (column, packet, . . . ).

In addition, it is also necessary that the diameter be small enough to be effective and to offer a large contact surface for the adsorption and therefore to generate an optimum treatment capacity.

This is a compromise that is also to be related to the production yield. However, it is noted that to obtain a maximum number of granules, whose size is between 1 and 4 mm, it is necessary also to take into account the residual moisture level and the size of the grinding grids.

By way of example and based on the variable origin of the bark, it is seen that a grinding grid of 3.80 mm mesh, a residual moisture level of 8%, and a mesh sieve of greater than 1 mm lead to an optimized yield that is close to 55%.

Next, the granules are prepared to make them active.

The first stage is a stage for rinsing, washing, and elimination of the residual fines after the grinding stage and after the different transfers and storage stages.

Certain water-soluble compounds, such as tannins, essentially, or other phenolic compounds, are partially released into the wash water, and simultaneously the bark absorbs water, causing a swelling by hydration.

The thus pre-prepared granules are next activated to impart to them ion exchange functionalities. A solution for solubilization of tannins and phenolic compounds is used, with the order of these two treatments being unimportant.

The activation of the granules is obtained in a known way by an acid treatment, in this case nitric acid at 0.1 M, i.e., at 0.1 mol per liter.

The acid causes exchanges of the salts Na, K, Ca and Mg, to cite the primary compounds of the ion exchanger sites by H⁺ protons.

The monitoring is implemented by a measurement of the conductivity based on pH.

The treatment time is defined when the conductivity reaches a horizontal asymptote, generally when the solution reaches a maximum acidity, i.e., a pH on the order of 1, with the conductivity able to reach approximately the values of 40 ms/cm.

The bark is next rinsed again to eliminate the acid solution.

As a result, the granules regain a pH close to 7 and therefore neutrality.

Simultaneously, the conductivity returns to the conductivity of the distilled water.

During this phase, the water-soluble compounds are again eliminated.

Nevertheless, water-soluble compounds still exist, and the latter should no longer be released subsequently during the use of the finished product for purposes of treating fluids, in particular treating water for the purpose of the recovery of heavy metals and radionuclides.

Thus, it is necessary to stabilize the thus-activated granules that are ready to be used for preventing any subsequent release of water-soluble compounds.

A solution for solubilization consists in treating said granules by making them undergo an oxidation reaction called a Fenton oxidation. This oxidation reaction causes a reduction in the size of tannins or other phenolic compounds, thus making them more easily extractable. These soluble compounds are then eliminated in the wash waters, preventing their subsequent solubilization during the filtration phases for the purpose of retaining radionuclides and heavy metals since these water-soluble compounds are absent.

This solubilization treatment relies on the Fenton oxidation reaction. This reaction is illustrated below:

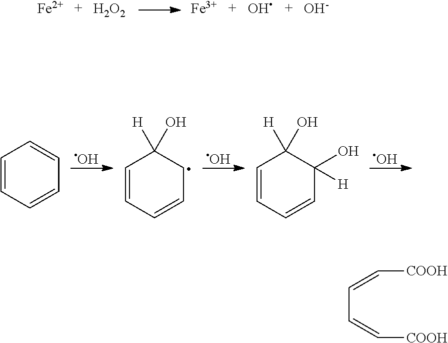

Thus, it is noted that this reaction makes possible the opening of rings, the reduction in the size of molecules, then making possible their entrainment and their elimination in the wash waters during the preparation of the bark.

In addition, this reaction causes the opening of the benzene rings of lignins to form carboxyl groups and thus to increase the number of sites available for adsorption.

To provide an example, 5 g of raw bark sieved in a range of 1 to 4 mm is treated.

The advantage of this granulometric range is that it avoids clogging while offering a satisfactory exchange surface.

The resulting granules are suspended in distilled water (500 ml) for 2 hours at ambient temperature for rinsing and for elimination of fines.

These rinsed granules are introduced into 250 ml of a solution of hydrogen peroxide H₂O₂ (50 mmol) and in the presence of FeSO₄ (0.5 mmol).

Stirring of the mixture at ambient temperature for 1 hour and 45 minutes, in particular by magnetic stirring.

The granules, after filtration on sintered glass with a porosity of 3, are regenerated, activated in 250 ml of an H₂SO₄ solution (0.1 M).

3.29 g of granules or a mass yield of 66% is obtained.

In a first step, the adsorption of lead, which is the closest element to uranium in terms of physical properties (charge, size, mass, density), while being simple to handle, is metered on these granules.

100 mg of granules that are treated as above is placed in suspension in 10 ml of a lead solution (concentration of between >0 and 2,000 ppm), while being stirred for 2 hours, in particular a magnetic stirring, at ambient temperature. The lead is metered by absorption spectrometry by being brought to the characteristic absorption lines, in particular 217 nm.

The tannins that are released are metered by spectrometry at 760 nm by the Folin reagent, the so-called Folin Ciocalteu method.

It is compared relative to control granules that have only undergone an acid treatment under the same conditions, namely H₂SO₄ (0.1 M).

The results are as follows:

| | Control | Fenton Oxidation |
|---|---|---|
| | Granules | Granules - Lead |
| qₘₐₓ (meq/g) | 0.162 | 0.220 |
| b (Langmuir's Constant) 1/meq | 0.70 | 1.3 |
| Phenols (Tannins) mg/g | 3.00 | 0.14 |

qₘₐₓ: Maximum capacity of metal cations adsorbed per unit of mass of bark.
b: Adsorption/desorption equilibrium constant.
Phenols (tannins): Equivalent mg of gallic acid per g of bark.

A 95% reduction in tannin waste and an adsorption capacity qₘₐₓ that is increased by 35% are noted.

These results are those relative to the adsorption capacity of bark that passes through equilibrium reactions between the metal cations and the bark, by means of an adequate contact time.

This is reflected by adsorption isotherms: see FIGS. 1 and 2 relating to the quantity of metal cations that are adsorbed per unit of mass of bark and the concentration of metal cations that remain in solution, with the trials being conducted at a constant temperature.

The maximum adsorption capacity is calculated from the Langmuir mathematical model:

qmax.=q(1+b·cᵣₑₛ)/(b·cᵣₑₛ)

The desired object is to reach the highest adsorption capacity qₘₐₓ.

As parameters, there are therefore the following:
q: Adsorption capacity at equilibrium
qₘₐₓ: Maximum quantity of metal cations adsorbed per unit of mass of bark
cᵣₑₛ: Solute concentration at equilibrium in the liquid phase
b: Adsorption/desorption equilibrium constant.

The coefficient b depends on the nature of the adsorbent-adsorbate pair. It is based on the interaction energy between the solute molecules and the substrate, under the action of the temperature.

The Langmuir model is valid only if the measurements are taken on assumed monolayer materials, i.e., that the following hypotheses are complied with:
Presence of several adsorption sites on the surface of the bark,
Each site can adsorb a single molecule,
Each site has the same affinity for the solutes,
The activity of one given site does not affect the activity of adjacent sites.

The carboxylic functions (pectins, hemicelluloses) or phenolic hydroxyls (lignins) are responsible for the adsorption.

The affinity of the substrate that is made of lignocellulosic material is selective and dependent upon the characteristics of the metals to be adsorbed (polarizability, hydrogenation enthalpy, number of single electrons).

It is noted that in the presented case of the Douglas fir granules, the lead is particularly well adsorbed.

In a second step, granules are prepared in the same way as above, and trials are conducted on the adsorption of uranium, directly.

100 mg of granules is placed in suspension in 10 ml of a solution that contains uranium (concentration of between >0 and 2,000 ppm), while being stirred for 2 hours, in particular a magnetic stirring, at ambient temperature.

The uranium is metered by alpha-spectrometry.

The tannins that are released are metered by spectrometry at 760 nm by the Folin reagent, the so-called Folin Ciocalteu method.

It is compared relative to control granules that have only undergone an acid treatment under the same conditions, namely H₂SO₄ (0.1 M).

The results are as follows:

| | | Fenton Oxidation |
|---|---|---|
| | Control Granules | Granules - Uranium |
| qₘₐₓ (meq/g) | 0.509 | 0.630 |
| b (Langmuir's Constant) 1/meq | 1.00 | 1.00 |
| Phenols (Tannins) mg/g | 3.00 | 0.14 |

A 95% reduction in waste and an adsorption capacity qₘₐₓ that is increased by 23% are noted.

The adsorption isotherms of FIGS. 3 and 4 relate to the quantity of metal cations that are adsorbed per unit of mass of bark and the concentration of metal cations that remain in solution, with the trials being conducted at constant temperature.

In a third step, granules are prepared in the same way as above, and trials are conducted on the adsorption of barium, chemical analog of radium, too dangerous to be handled at such concentrations.

100 mg of granules that are treated as above are placed in suspension in 10 ml of a solution that contains barium (concentration of between >0 and 2,000 ppm), while being stirred for 2 hours, in particular a magnetic stirring, at ambient temperature.

The barium is metered by adsorption spectrometry by being placed at characteristic absorption lines, in particular 553 nm.

The tannins that are released are metered by spectrometry at 760 nm by the Folin reagent, the so-called Folin Ciocalteu method.

It is compared relative to control granules that have only undergone an acid treatment under the same conditions, namely H₂SO₄ (0.1 M).

The results are as follows:

| | | Fenton Oxidation |
|---|---|---|
| | Control Granules | Granules - Barium |
| qₘₐₓ (meq/g) | 0.580 | 0.640 |
| b (Langmuir's Constant) 1/meq | 0.50 | 0.32 |
| Phenols (Tannins) mg/g | 3.00 | 0.14 |

A 95% reduction in waste and an adsorption capacity qₘₐₓ that is increased by 10% are noted.

The adsorption isotherms of FIGS. 5 and 6 relate to the quantity of metal cations that are adsorbed per unit of mass of bark and the concentration of metal cations that remain in solution, with the trials being conducted at constant temperature.

These results are then validated for the radium that is metered by gamma-spectrometry at concentrations that allow its handling.

According to an enhancement of the process according to this invention, it is possible to repeat the hydrogen peroxide attack, the so-called Fenton reaction, on granules several times so as to improve the results as regards adsorption.

It can be assumed, without this interpretation being limiting, that the free radicals have a limited service life.

1. Process for the treatment of a substrate that is made of lignocellulosic material for the adsorption of radionuclides in fluids that are loaded with radionuclides, characterized in that it consists in carrying out the following stages:
Preparation of lignocellulosic material that is divided by rinsing and that is subjected to granulometric sorting,
Submission of the lignocellulosic material to an oxidation,
Activation of the material by an acid treatment, and
Rinsing.

2. Process for the treatment of a substrate that is made of lignocellulosic material for the adsorption of radionuclides according to claim 1, wherein the oxidation reaction is a Fenton reaction.

3. Process for the treatment of a substrate that is made of lignocellulosic material for the adsorption of radionuclides according to claim 1, wherein the oxidation reaction is conducted at ambient temperature.

4. Process for the treatment of a substrate that is made of lignocellulosic material for the adsorption of radionuclides according to claim 1, wherein the lignocellulosic material consists of wood bark.

5. Process for the treatment of a substrate that is made of lignocellulosic material for the adsorption of radionuclides according to claim 1, wherein the granulometric sorting of the lignocellulosic material retains the particles with dimensions of between 1 and 4 mm.

6. Process for the treatment of a substrate that is made of lignocellulosic material for the adsorption of radionuclides according to claim 1, wherein the lignocellulosic material consists of granules of bark of the Douglas-fir variety.

7. A lignocellulosic material treated by the process according to claim 1 for trapping radionuclides contained in a fluid that is loaded with radionuclides.

8. Granules of bark of the Douglas-fir variety treated by the process according to claim 1 for trapping uranium.

9. Granules of bark of the Douglas-fir variety that are treated by the process according to claim 1 for trapping radium.

10. A method of trapping radionuclides in a fluid that is loaded with radionuclides, comprising exposing the lignocellulosic material according to claim 7 to said fluid that is loaded with radionuclides.

11. The method according to claim 10, wherein the lignocellulicosic material consists of granules of bark of the Douglas-fir variety, and the radionuclides loaded in said fluid consist of uranium.

12. The method according to claim 10, wherein the lignocellulicosic material consists of granules of bark of the Douglas-fir variety, and the radionuclides loaded in said fluid consist of radium.
